(19) United States
(12) Patent Application Publication
(10) Pub. No.: US 2004/0241265 A1
(43) Pub. Date: Dec. 2, 2004

(54) Material supplying device for rubber injection machine

(76) Inventor: Chin-Yung Peng, Chang-Hua City (TW)

Correspondence Address: CHIN-YUNG PENG, P.O. BOX 487, Chang-Hua City, 500, TW

(21) Appl. No.: 10/445,003

(22) Filed: May 27, 2003

(51) Int. Cl. B29C 45/07

(52) U.S. Cl. 425/190; 425/543

(57) ABSTRACT

A rubber injection machine includes a top board with two grooves so that a material supply device is movably engaged with the grooves. A material injection device is movably connected to an underside of the top board and a nozzle of the material supply device is located above the material injection device. A lower board is connected to a hydraulic device and a mold assembly is supported on the hydraulic device. The material injection device is movable to match with the mold assembly and then removed from the mold assembly. The material injection device is not heated with the mold assembly.

### FIELD OF THE INVENTION

The present invention relates to rubber injection machine that includes a material injection device movable between the -material supply nozzle and the mold assembly so as to prevent from being heated with the mold assembly.

### BACKGROUND OF THE INVENTION

A conventional rubber injection machine 90 is disclosed in FIG. 3 and generally includes a top board 91 and a lower board 93. A material receiving member 96 is connected to the top board 91 and a space 961 is defined in the receiving member 96 so as to receive a pre-set amount of rubber therein. A passage 962 is defined in the underside of the receiving member 96. so that the rubber in the space 961 can be sent to the cavities 95 1 in the mold assembly 95 connected to the lower board 93. The mold assembly 95 is raised by a hydraulic device 94 and matched with the receiving member 96 so that the cavities 951 may receive the rubber sent via the passage 962. The mold assembly 95 is heated to make the rubber in the cavities 951 become desired status so as to form products that has the same shape of the cavities 951. Nevertheless, the rubber left in the receiving member 96 is also heated and cannot be re-used again so that much of the material is wasted. Besides, the rubber has to be re-filled into the space 961 in the receiving member 96 every time before the injection process so that it wastes too much time.

The present invention intends to provide a material injection device movable between the material supply nozzle and the mold assembly so as to prevent from being heated with the mold assembly.

### SUMMARY OF THE INVENTION

In accordance with one aspect of the present invention, there is provided a rubber injection machine which comprises a top board and a material supply device is movably connected to the top board. A material injection device is movably connected to an underside of the top board so as to receive material such as rubber from a nozzle of the material supply device. A lower board is connected to a hydraulic device and a mold assembly is supported on the hydraulic device. The material injection device is movable to match with or removed from the mold assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show the rubber injection machine of the present invention;

FIG. 2 is a front view to show the rubber injection machine of the present invention, and

FIG. 3 is a side view to show a conventional rubber injection machine.

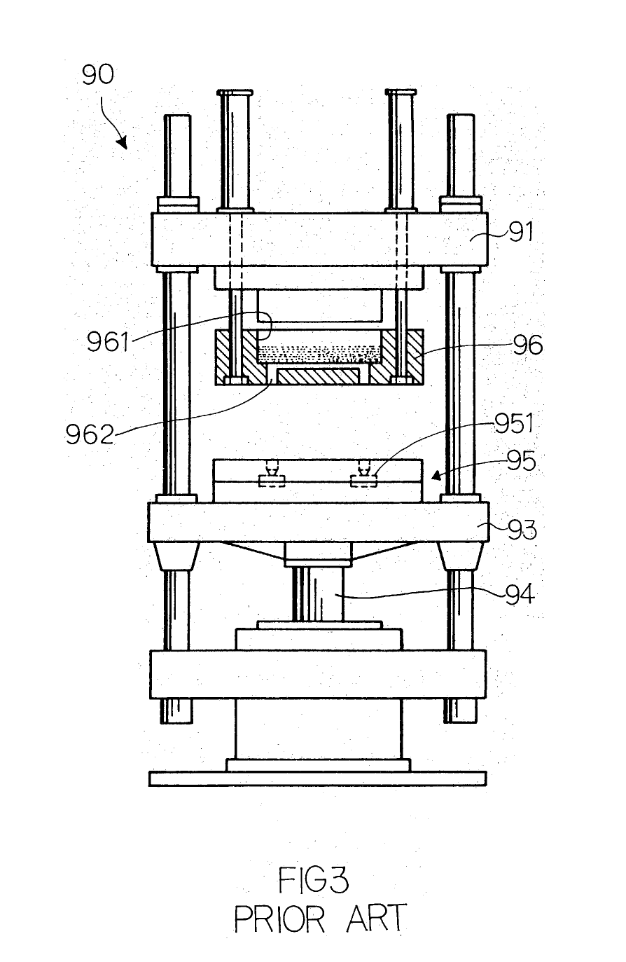

### DETAILED DESCRIPTION OF THE PREFERRED EMBODIMENT

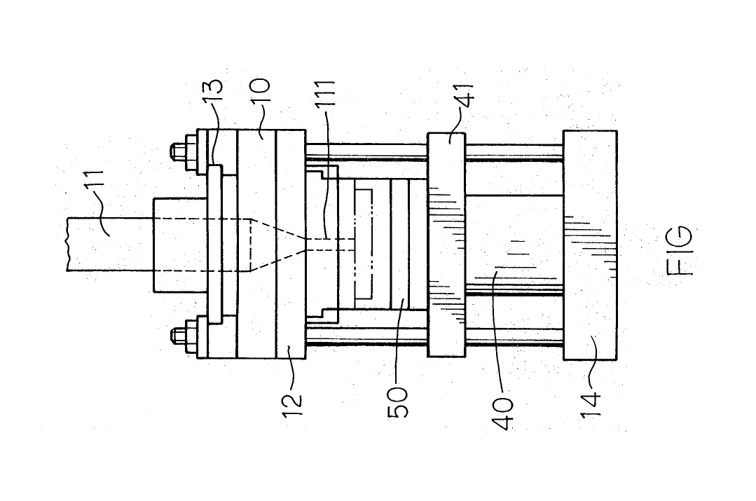

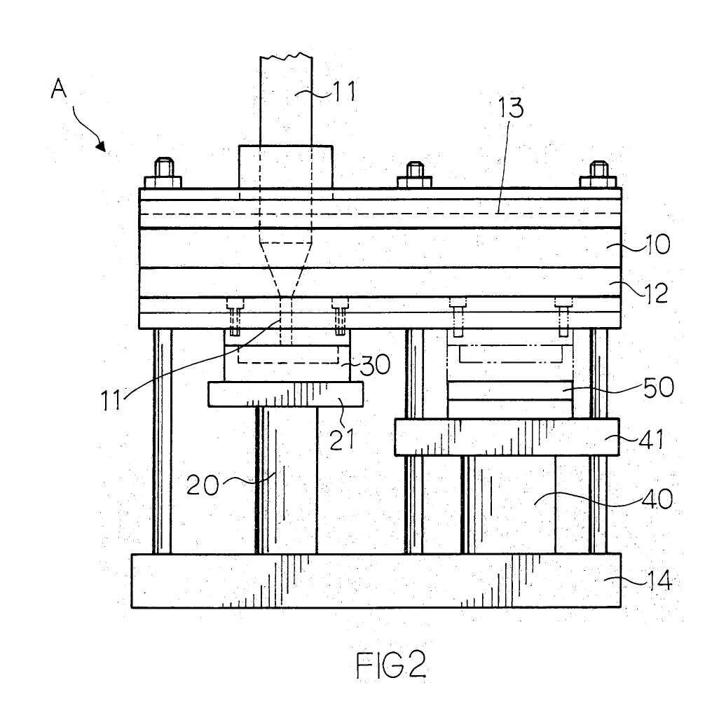

Referring to FIGS. 1 and 2, the rubber injection machine “A” of the present invention comprises a top board which as two grooves 13 defined in two facing insides thereof and a material supply device 11 is movably engaged with the two grooves 13. An under board 12 is connected to an underside of the top board 10 and a material injection device 30 is movably connected to the under board 12. A nozzle 111 of the material supply device 11 can be, arranged to be positioned above the material injection device 30 which is supported on a support board 21 on a hydraulic device 20.

A lower board 14 is located below the top board 10 and connected to the top board 10 by several posts. A hydraulic device 40 is connected to the lower board 14 and a mold assembly 50 is supported on a support board 41 of the hydraulic device 40. The material injection device 30 is movable to match with the mold assembly 50 so that the a pre-set amount of rubber sent via the nozzle 111 of the material supply device 11 can be injected into the cavities in the mold assembly 50. The material injection device 30 is then removed from the mold assembly 50 to receive another amount of rubber via the nozzle 111 of the material supply device 11, and the mold assembly 50 is heated and sulfurized. This efficiently saves processing time and the rubber in the material injection device 30 is not heated with the mold assembly 50.

While we have shown and described the embodiment in accordance with the present invention, it should be clear to those skilled in the art that further embodiments may be made without departing from the scope of the present invention.

What is claimed is:

1. A rubber injection machine comprising:
a top board;
a material supply device movably connected to the top board, a material injection device movably connected to an underside of the top board, and
a lower board with a hydraulic device connected thereto, a mold assembly supported on the hydraulic device and the material injection device movable to match with the mold assembly.

2. The rubber injection machine as claimed in claim 1, wherein two grooves are defined in two facing insides of the top board and the material supply device is movably engaged with the grooves.
